(19) United States
(12) Patent Application Publication
(10) Pub. No.: US 2018/0342749 A1
(43) Pub. Date: Nov. 29, 2018

(54) METHOD OF CONTROLLING FUEL CELL SYSTEM

(71) Applicant: HONDA MOTOR CO., LTD., Tokyo (JP)

(72) Inventors: Yuji Okamura, Wako-shi (JP); Koichi Takaku, Wako-shi (JP)

(21) Appl. No.: 15/980,930

(22) Filed: May 16, 2018

(30) Foreign Application Priority Data
May 23, 2017 (JP) 2017-101567

(51) Int. Cl. H01M 8/04828

(52) U.S. Cl. CPC H01M 8/04843

(57) ABSTRACT

A control unit of a fuel cell system issues an instruction to open/close the drain valve after placing a drain valve provided for a gas liquid separator in an open state and discharging water from the gas liquid separator. Therefore, when the drain valve is opened/closed, the drain valve vibrates.

### CROSS-REFERENCE TO RELATED APPLICATION

This application is based upon and claims the benefit of priority from Japanese Patent Application No. 2017-101567 filed on May 23, 2017, the contents of which are incorporated herein by reference.

### BACKGROUND OF THE INVENTION

### Field of the Invention

The present invention relates to a method of controlling a fuel cell system including a fuel cell that has an electrolyte, and an anode and a cathode on both sides of the electrolyte.

### Description of the Related Art

As is known in the art, the fuel cell includes an electrolyte (e.g., solid polymer membrane), and an anode and a cathode on both sides of the electrolyte. A fuel gas such as hydrogen is supplied to the anode, and an oxygen-containing gas such as a compressed air is supplied to the cathode to generate electricity. At least some of the fuel gas and the oxygen-containing gas are consumed. The fuel gas and the oxygen-containing gas that have not been consumed in the reactions are discharged from the anode electrode and the cathode electrode as the fuel exhaust gas and the oxygen-containing exhaust gas to a fuel exhaust gas channel and an oxygen-containing exhaust gas channel, respectively. The fuel cell system is formed by providing the fuel cell along with a reactant gas supply device, a reactant gas discharge device, etc. required for the above supply and discharge.

The fuel exhaust gas discharge channel is provided with a gas liquid separator for separating water contained in the fuel exhaust gas. During steady operation of the fuel cell, for example, a drain valve (exhaust gas water drainage valve) is opened when predetermined quantity of water is stored in the gas liquid separator. As a result, water in the gas liquid separator is discharged.

In the case where the water is retained in the fuel cell system after stopping operation of the fuel cell, the water may freeze to ice depending on the environment where the fuel cell is used. In an attempt to address the problem, in Japanese Laid-Open Patent Publication No. 2008-077959, it is proposed to open a drain vale (exhaust gas water drainage valve) provided for a fuel exhaust gas discharge channel, if it is determined that the temperature at the drain valve is 0° C. and the outside air temperature is going to be the freezing temperature or less. This technique is an attempt to blow water attached to the drain valve by discharging the fuel gas through the drain valve and to prevent freezing of a purge valve.

### SUMMARY OF THE INVENTION

The water in the gas liquid separator can be discharged only by blowing as described in Japanese Laid-Open Patent Publication No. 2008-077959. However, it is difficult to remove the water attached to portions other than flow channels of hydrogen, e.g., the surface of the drain valve. If freezing of the water retained in such a portion occurs, it becomes difficult to open/close the drain valve.

A main object of the present invention is to provide a method of controlling a fuel cell system which makes it possible to eliminate the concern about freezing of the drain valve.

According to one embodiment of the present invention, a method of controlling a fuel cell system having a fuel cell and a fuel exhaust gas discharge channel is provided. The fuel exhaust gas discharge channel includes a gas liquid separator configured to separate water contained in a fuel exhaust gas discharged from an anode of the fuel cell, and a drain valve configured to discharge the water from the gas liquid separator.

The method includes the steps of discharging the water from the gas liquid separator by opening the drain valve, vibrating the drain valve to remove the water attached to the drain valve, and closing the drain valve.

As described above, in the present invention, the drain valve is vibrated after the water in the gas liquid separator is discharged from the drain valve. Therefore, even when the water is attached to portions other than flow channels of the fuel gas, such as the surface of the drain valve, the water is removed from the drain valve by mechanical vibration. That is, it is possible to remove the water from the drain valve. Thus, even under the operating environment where freezing may occur, e.g., in the case where the outside air temperature is the freezing temperature or less, it is possible to eliminate concern that the drain valve is frozen.

Further, since freezing of the drain valve is prevented, the drain valve can perform predetermined opening/closing operation. Therefore, it becomes possible to carry out steady operation of the fuel cell system.

During an operation period in which the fuel cell generates electric power, there is no particular concern of freezing since the fuel cell system is at a predetermined temperature. Therefore, preferably, the drain valve is vibrated when the fuel cell is at a lower temperature after operation of the fuel cell is stopped and a condition for expecting freezing is satisfied. Thus, it is possible to avoid freezing of the drain valve during a period in which operation of the fuel cell is stopped. Therefore, it is possible to immediately open/close the drain valve when operation of the fuel cell is resumed.

Preferably, the drain valve is configured to be opened/closed by energizing the drain valve. In this case, by energizing/stopping energization of the drain valve, it is possible to vibrate the drain valve easily. Preferably, the valve member of the drain valve is displaced in a horizontal direction. In this case, the water removed from the drain valve can move to the lower side easily under the force of gravity. In this manner, it becomes easy to a greater extent to remove the water from the drain valve.

Further, preferably, the drain valve is opened/closed multiple times. In this case, since the drain valve is vibrated multiple times, water attached to the drain valve can be removed easily to a greater extent.

In order to discharge the water from the gas liquid separator of the fuel cell system whose operation is stopped, for example, it only needs to supply the fuel gas to the anode.

In this case, it is preferable to place the drain valve in the open state when the pressure of the anode in the fuel gas supply channel, the anode, and the fuel gas exhaust gas discharge channel becomes a predetermined value or more. It is because, since the pressure of the fuel gas is large, it becomes easy to discharge the water from the gas liquid separator.

In the present invention, the water in the gas liquid separator of the fuel cell system is discharged through the drain valve that is in the open state, and thereafter, the drain valve is vibrated. By this vibration, the water attached to the surface of the drain valve and so on is removed. Accordingly, it is possible to remove the water attached to the drain valve. Therefore, even in the environment where freezing is expected, it is possible to eliminate the concern that the drain valve is frozen.

Freezing of the drain valve is prevented as described above, and the drain valve performs predetermined opening/closing operation required at the time of operating the fuel cell system. Therefore, it becomes possible to perform steady operation of the fuel cell system.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a view schematically showing structure of main components of a fuel cell system where a method of controlling a fuel cell system according to the present invention is performed;

FIG. 2 is a cross sectional side view schematically showing main components of a drain valve provided at a gas liquid separator of a fuel cell system in FIG. 1;

FIG. 3 is an enlarged cross sectional side view showing main components of the drain valve in FIG. 2 with the drain valve in an open state;

FIG. 4 is a flowchart schematically showing a flow of the method of controlling the fuel cell system according to the embodiment of the present invention.

### DESCRIPTION OF THE PREFERRED EMBODIMENTS

Hereinafter, a preferred embodiment of a method of controlling a fuel cell system according to the present invention will be described with reference to the accompanying drawings.

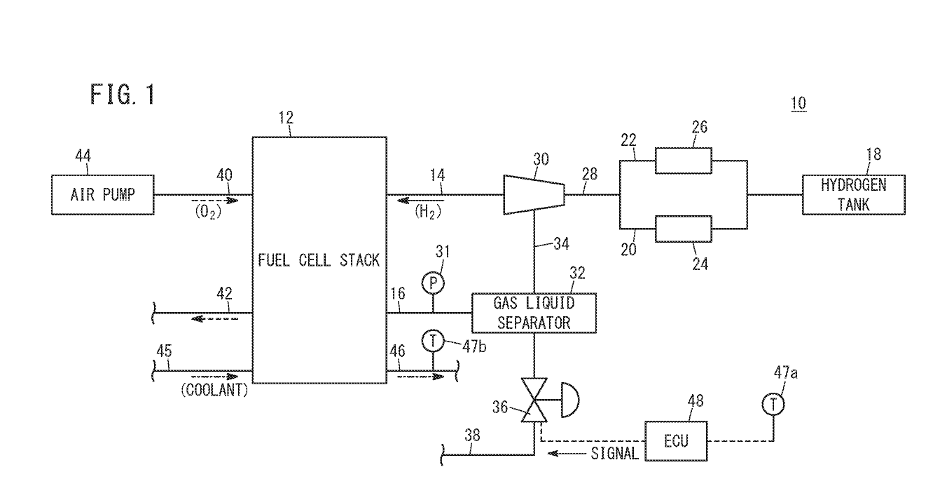

Firstly, the fuel cell system will be described with reference to FIG. 1. The fuel cell system 10 includes a fuel cell stack 12 formed by stacking a plurality of fuel cells (not shown) together. For example, each of the fuel cells is formed by sandwiching a membrane electrolyte assembly between a pair of separators. The electrolyte electrode assembly includes an anode, a cathode, and an electrolyte interposed between the anode and the cathode.

The electrolyte is a solid polymer membrane. It should be noted that this structure is known and thus, the detailed description is omitted.

Further, the fuel cell system 10 includes a hydrogen supply channel 14 (fuel gas supply channel) and a hydrogen discharge channel 16 (fuel exhaust gas discharge channel) provided for the fuel cell stack 12. A fuel gas is supplied to the anode through the hydrogen supply channel 14, and a fuel exhaust gas is discharged from the anode through the hydrogen discharge channel 16. A hydrogen tank 18 storing high pressure hydrogen as a fuel gas is connected to the hydrogen supply channel 14.

The hydrogen supply channel 14 bifurcates. Therefore, the hydrogen supply channel 14 includes a first branch channel 20 and a second branch channel 22. A first injector 24 and a second injector 26 are provided for the first branch channel 20 and the second branch channel 22, respectively. The first branch channel 20 and the second branch channel 22 are merged into a merged channel 28, on the downstream side of the first injector 24 and the second injector 26, and an ejector 30 is provided for the merged channel 28.

A pressure sensor 31 is provided for the hydrogen discharge channel 16, and a gas liquid separator 32 is connected to the hydrogen discharge channel 16. A circulation channel 34 starting from the gas liquid separator 32 is connected to the ejector 30. Further, a water drainage channel 38 is provided at the bottom of the gas liquid separator 32, for discharging water through a drain valve 36.

Further, the fuel cell system 10 includes an air supply channel 40 (oxygen-containing gas supply channel for supplying the compressed air as an oxygen-conning gas to the cathode, and an air discharge channel 42 (oxygen-containing exhaust gas discharge channel) for discharging the exhaust compressed air from the cathode. An air pump 44 (compressor) for compressing the atmospheric air, and supplying the atmospheric air is provided for the air supply channel 40.

Further, a coolant supply channel 45 for supplying the coolant to the fuel cell stack 12, a coolant discharge channel 46 for discharging the coolant from the fuel cell stack 12, a first temperature sensor 47a for measuring the outside air temperature, a second temperature sensor 47b for measuring the temperature of the coolant, and a control unit (ECU) 48 for implementing the overall control of the fuel cell stack 12 are installed along with the fuel cell stack 12. The fuel cell system 10 has the structure as described above. The coolant is also referred to as the cooling medium in FIG. 1.

The ECU 48 determines whether or not the outside air temperature measured by the first temperature sensor 47a is a predetermined threshold value or less. Further, the ECU 48 determines whether or not the coolant temperature measured by the second temperature sensor 47b is a predetermined threshold value or less. As described later, when it is determined that both of the outside air temperature and the coolant temperature have the predetermined threshold values or less, it is considered that freezing may be occurring, and predetermined control is implemented.

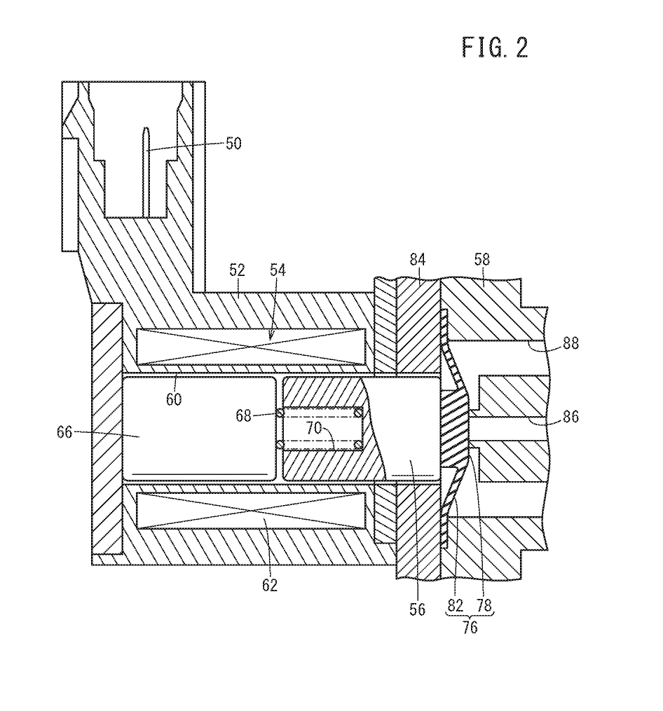

FIG. 2 is a cross sectional side view schematically showing main components of the drain valve 36. In this case, the drain valve 36 is a breed valve including a housing 52 having a molded connection terminal 50 connected to a harness (not shown) extending from the ECU 48, a solenoid part 54 accommodated in the housing 52, a plunger 56, and a valve plug 58.

An insertion hole 60 is formed in the housing 52, and an electromagnetic coil 62 is provided surrounding the insertion hole 60 from outside. A fixed core 66 and the plunger 56 are inserted into the insertion hole 60. A return spring 68 is provided between the fixed core 66 and the plunger 56. The majority part of the return spring 68 is accommodated in a spring hole 70 formed in the plunger 56.

The plunger 56 is made up of a movable core which is displaced when the electromagnetic coil 62 is energized or de-energized (the electric power to the electromagnetic coil 62 is shut off). A central thick part 78 of a diaphragm 76 as a valve member is seated at a distal end of the plunger 56. Further, the diaphragm 76 includes a peripheral thin part 82 that is continuous with a radially outer portion of the central thick part 78. A portion of the peripheral thin part 82 is inclined in a tapered manner toward the cap member 84 and toward the outer edge portion of the peripheral thin part 82. The outer edge portion of the outer thin part 82 is sandwiched and held between the cap member 84 and the valve plug 58.

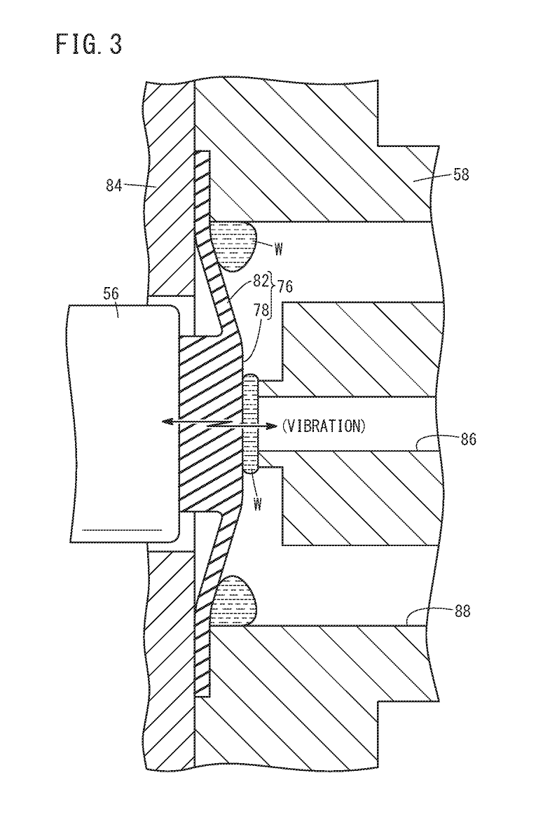

For example, the valve plug 58 has a substantially circular disk shape. An inlet port 86 is formed at a central portion of the valve plug 58, and an annular outlet port 88 is formed surrounding the inlet port 86. As shown in FIG. 2, when the central thick part 78 of the diaphragm 76 is seated near the inlet port 86, the drain valve 36 is in a closed state. Conversely, as shown in FIG. 3 which is an enlarged view, when the central thick part 78 is away from the inlet port 86, the drain valve 36 is in an open state.

Next, a method of controlling the fuel cell system 10 according to the embodiment of the present invention will be described. In an example described below, it is assumed that the fuel cell system 10 is mounted in a fuel cell vehicle (not shown) such as a fuel cell electric automobile and the fuel cell system 10 is controlled.

When the fuel cell stack 12 operates, hydrogen as a fuel gas is supplied from the hydrogen tank 18 to the hydrogen supply channel 14. After the hydrogen passes through the first injector 24 of the first branch channel 20 or the second injector 26 of the second branch channel 22, the hydrogen flows through the ejector 30 of the merged channel 28 and then is supplied to the anode of each of the fuel cells of the fuel cell stack 12.

In the meanwhile, the compressed air as the oxygen-containing gas is supplied to the air supply channel 40 through the air pump 44. After the compressed air is humidified by an exhaust compressed air described later, the compressed air is supplied to the cathode of each of the fuel cells of the fuel cell stack 12.

When the reactant gases are supplied to the fuel cell stack 12 as described above, electrode reactions are induced at the anode and the cathode of each of the fuel cells. Thus, power generation is performed. It should be noted that a coolant flow field is formed in the fuel cell stack 12, and the coolant supplied through the coolant supply channel flows through the coolant flow field.

The compressed air supplied to the cathode and partly consumed is discharged as the exhaust compressed air to the air discharge channel 42. The exhaust compressed air is a humidified gas containing water produced in the electrode reaction at the cathode. In a humidifier (not shown), the exhaust compressed air humidifies the oxygen-containing gas that is newly supplied to the cathode. Thereafter, the exhaust compressed air is set to have a predetermined pressure, and discharged to the outside of the fuel cell system 10.

In the meanwhile, the hydrogen supplied to the anode and partly consumed is discharged as the exhaust hydrogen (fuel exhaust gas) to the hydrogen discharge channel 16. While the exhaust hydrogen flows through the hydrogen discharge channel 16, the exhaust hydrogen is supplied into the gas liquid separator 32 and is separated into the gas phase and the water. After removal of the water, the exhaust hydrogen in the gas phase is sucked into the ejector 30 through the circulation channel 34, and supplied again to the anode together with newly supplied hydrogen.

Normally, since the central thick part 78 of the diaphragm 76 is seated at a position close to the inlet port 86, the drain valve 36 is in the closed state (see FIG. 2). When the water stored in the gas liquid separator 32 reaches a predetermined quantity, the drain valve 36 is opened. At this time, the electric current is supplied from the ECU 48 to the connection terminal 50, and the electromagnetic coil 62 is energized. As a result, by the magnetic force generated around the electromagnetic coil 62, the plunger 56 as the movable core presses the return spring 68 accommodated in the spring hole 70, and meanwhile, the plunger 56 is displaced toward the fixed core 66. At this time, the return spring 68 is contracted.

As a result, as shown in FIG. 3, the central thick part 78 goes away from the inlet port 86. That is, the drain valve 36 is placed in the open state, and the water flows into the inlet port 86. The water from the inlet port 86 diffuses in the radially outward direction of the valve plug 58 and is discharged from the outlet port 88, which surrounds the inlet port 86 in an annular manner. Thereafter, the water reaches the water drainage channel 38.

In the case where power generation of the fuel cell stack 12 is stopped to stop the operation of the fuel cell vehicle, the supply of the hydrogen to the anode is stopped, and the supply of the compressed air to the cathode is stopped. Further, the energization of the electromagnetic coil 62 is stopped, and the magnetic force is lost. As a result, the return spring 68 is released from the pressure of the plunger 56. Therefore, the return spring 68 is expanded by its elastic restoring force. As a result, the elastic force of the return spring 68 is applied to the plunger 56, and the plunger 56 is displaced away from the fixed core 66. Thus, the drain valve 36 is placed in the closed state.

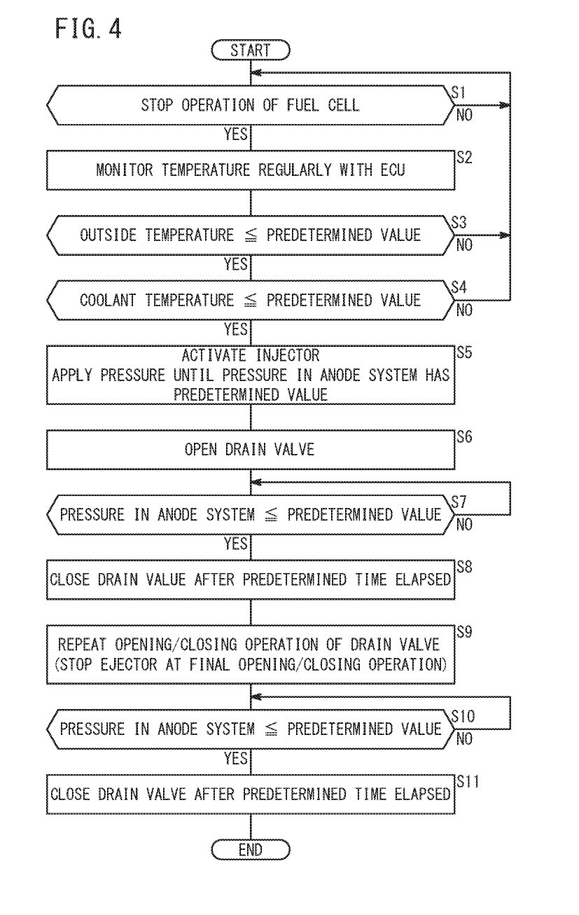

The method of controlling the fuel cell system 10 according to the embodiment of the present invention is performed during the above period where operation is stopped (step S1) as shown in FIG. 4, which is a schematic flowchart. That is, also in the state where the operation of the fuel cell stack 12 is stopped, the ECU 48 as a control unit regularly obtains temperature information from the first temperature sensor 47a and the second temperature sensor 47b (step S2), and determines whether or not the outside air temperature and the coolant temperature are threshold values or less (steps S3 and S4). If one of the temperatures exceeds its threshold value, the ECU 48 does not issue any instruction to open/close the drain valve 36, and the routine returns to step S1.

In contrast, if it is determined that both of the outside air temperature and the coolant temperature are the threshold values or less, the ECU 48 activates the first injector 24 or the second injector 26 (step S5). Thus, since the hydrogen is supplied to the anode of the fuel cell stack 12, the pressures in the hydrogen supply channel 14, the anode, and the hydrogen discharge channel 16 (hereinafter these components are also referred to as the “anode system”, collectively) are increased. In this case, the hydrogen is blocked (the flow of the hydrogen is stopped) in the gas liquid separator 32, and the hydrogen is not circulated as described above.

When the ECU 48 determines that the pressure of the hydrogen in the anode system detected by the pressure sensor 31 provided for the hydrogen discharge channel 16 becomes the predetermined values or more, the drain valve 36 is placed in the open state (step S6). That is, in the same manner as described above, the electromagnetic coil 62 is energized, and the plunger 56 is displaced toward the fixed core 66. As a result, the central thick part 78 moves away from the inlet port 86.

Therefore, the hydrogen filled in the anode system flows into the inlet port 86 and flows out of the outlet port 88 (the hydrogen is discharged from the outlet port 88). By the discharge of the hydrogen, the water remaining in the gas liquid separator 32 is discharged. That is, a discharging step is performed.

The discharge of the hydrogen is continued until the pressure in the anode system becomes a predetermined value or less (step S7). It should be noted that the predetermined value is set to a pressure value at which the water in the gas liquid separator 32 substantially disappears. The pressure value is measured beforehand.

Then, if the ECU 48 determines that the pressure in the anode system becomes a predetermined value or less, the routine proceeds to step S8. That is, after elapse of short time, according to an instruction from the ECU 48, the energization of the electromagnetic coil 62 is stopped. As a result, the plunger 56 is displaced away from the fixed core 66, and the central thick part 78 of the diaphragm 76 is seated at a position close to the inlet port 86, and closes the inlet port 86. In this way, the drain valve 36 is placed in the closed state.

After the water in the gas liquid separator 32 is discharged as described above, as shown in FIG. 3, in the drain valve 36, the water W may remain in some cases in minute clearance, e.g., between a peripheral thin part 82 of the diaphragm 76 and the portion close to the opening of the outlet port 88, and/or between the central thick part 78 and the portion close to the opening of the inlet port 86. At this time, in order to remove the water W, the step S9 which is a vibrating step is performed.

That is, in step S9, the ECU 48 issues an instruction to open/close the drain valve 36. Based on this opening/closing instruction, the energization/de-energization of the electromagnetic coil 62 for a short period of time,—in other words, the opening/closing of the drain valve 36—is repeated. That is, the plunger 56 moves back and forth in reciprocating motion at high speed, and the central thick part 78 of the diaphragm 76 is seated and unseated (moves away) repeatedly relative to the inlet port 86. As a result of such a phenomenon, the drain valve 36 vibrates. The vibration pushes the water W remaining in the clearance W out of the clearance. In this way, it is possible to remove the water W.

In this regard, the fuel cell vehicle is in the state where the operation is stopped as described above. Therefore, the gas liquid separator 32 stands upright with the longitudinal direction of the gas liquid separator 32 parallel with the vertical direction. Further, in the drain valve 36 provided at the bottom of the gas liquid separator 32, the diaphragm 76 as the valve member is repeatedly displaced in the horizontal direction. That is, in this case, the opening/closing direction of the drain valve 36 is the horizontal direction. Therefore, the water W removed from the clearance moves downward easily under the force of gravity. Accordingly, it is easy to a greater extent to remove the water W from the drain valve 36.

The opening/closing operation of the drain valve 36 is repeated, for example, ten times. Further, during the last opening/closing operation, the ECU 48 stops the first injector 24 or the second injector 26.

After the opening and closing is repeated a predetermined number of times, the energization of the electromagnetic coil 62 is continued, and the open state of the drain valve 36 is maintained. Meanwhile, the ECU 48 determines whether or not the pressure of the hydrogen in the anode system detected by the pressure sensor 31 is equal to a predetermined value or less (step S10). When the ECU 48 determines that the pressure of the hydrogen becomes the predetermined value or less, the routine proceeds to step S11 which is a closing step to place the drain valve 36 in the closed state by stopping the energization of the electromagnetic coil 62. Here, the control ends.

This control is repeated regularly while the fuel cell vehicle is stopped. If the fuel cell vehicle is stopped for a long period of time, since the water discharged from the gas liquid separator 32 is hardly left, the time period from the start to the end of the control shortens.

As a result of the above control, even if freezing may occur in the environment around the fuel cell vehicle, since the water is removed from the drain valve 36, freezing of the drain valve 36 can be avoided. In particular, since the water is removed through space between the diaphragm 76 and the valve plug 58, it is possible to prevent the diaphragm 76 from being attached to the valve plug 58, i.e., so called attachment of the diaphragm 76 to the valve plug 58. Accordingly, even in the environment where freezing may occur, the predetermined opening/closing operation of the drain valve 36 can be performed.

The present invention is not limited to the above described embodiment specially. Various modifications can be made without deviating from the gist of the present invention.

For example, the fuel cell system 10 for carrying out the control method according to the present invention is not limited to the in-vehicle applications. The fuel cell system 10 may be a stationary type.

Further, instead of the first temperature sensor 47a and the second temperature sensor 47b, other temperature detection means may be adopted. The position where the pressure sensor 31 is installed is not limited to the hydrogen discharge channel 16. The pressure sensor 31 may be installed at any position as long as the pressure sensor 31 can detect the pressure in the anode system. For example, the pressure sensor 31 may be installed in the hydrogen supply channel 14.

Further, in this embodiment, the drain valve 36 is a solenoid valve having the diaphragm 76 which is the valve member. However, the drain valve 36 may be other types of valve. Additionally, the drain valve 36 may be vibrated by means other than energization. The number of times the drain valve 36 vibrates is not limited to 10 specially.

Further, the fuel cell system is not limited to the above structure specially. Needless to say, various structures can be adopted.

What is claimed is:

1. A method of controlling a fuel cell system, the fuel cell system comprising:
a fuel cell;
a fuel exhaust gas discharge channel including
a gas liquid separator configured to separate water contained in a fuel exhaust gas discharged from an anode of the fuel cell; and
a drain valve configured to discharge the water from the gas liquid separator,
the method comprising the steps of:
discharging the water from the gas liquid separator by opening the drain valve;
vibrating the drain valve to remove the water attached to the drain valve; and
closing the drain valve.

2. The method of controlling the fuel cell system according to claim 1, wherein the discharging step, the vibrating step, and the closing step are performed while operation of the fuel cell is stopped and when a condition for expecting freezing is satisfied.

3. The method of controlling the fuel cell system according to claim 1, wherein, in the vibrating step, the drain valve is opened/closed by energization, and a valve member of the drain valve is displaced in a horizontal direction.

4. The method of controlling the fuel cell system according to claim 3, wherein, in the vibrating step, opening/closing operation of the drain valve is performed a plurality of times.

5. The method of controlling the fuel cell system according to claim 1, wherein the discharging step is performed while a fuel gas is supplied to the anode.

6. The method of controlling the fuel cell system according to claim 5, wherein, when pressure of the fuel gas in a fuel gas supply channel, the anode, and the fuel exhaust gas discharge channel becomes a predetermined value or more, the drain valve is placed in an open state, and the water is discharged from the gas liquid separator.
